(19) United States
(12) Patent Application Publication
(10) Pub. No.: US 2025/0158008 A1
(43) Pub. Date: May 15, 2025

(54) ELECTRODE MATCHING SYSTEM AND METHOD

(71) Applicant: Apple Inc., Cupertino, CA (US)

(72) Inventors: Qianwen Huang, San Jose, CA (US); Pengfei Xu, Suzhou (CN); Yongming Li, Tianjin (CN); He Li, Beijing (CN); Mark E. Wilcox, Morgan Hill, CA (US); Rajesh Kandibanda, Menlo Park, CA (US); Rejin Isaac, San Jose, CA (US)

(21) Appl. No.: 18/890,508

(22) Filed: Sep. 19, 2024

Related U.S. Application Data
(60) Provisional application No. 63/597,946, filed on Nov. 10, 2023.

(51) Int. Cl. H01M 4/04; H01M 10/04

(52) U.S. Cl. CPC H01M 4/04; H01M 10/04

(57) ABSTRACT

A battery electrode matching system includes one or more sensors configured to detect a first characteristic of a first electrode and a second characteristic of a second electrode, one or more signature applicators configured to mark the first electrode with a first signature and the second electrode with a second signature, and memory circuitry. The memory circuitry is configured to store a first profile corresponding to the first electrode, the first profile including first data indicative of the first characteristic and the first signature. The memory circuitry is also configured to store a second profile corresponding to the second electrode, the second profile including second data indicative of the second characteristic and the second signature.

### CROSS-REFERENCE TO RELATED APPLICATIONS

This application claims priority to U.S. Provisional Application No. 63/597,946, entitled “ELECTRODE MATCHING SYSTEM AND METHOD,” filed Nov. 10, 2023, which is hereby incorporated by reference in their entireties for all purposes.

### BACKGROUND

The present disclosure relates generally to battery cells, and more specifically to electrode marking and matching in battery cells.

A battery cell may include electrolyte, one or more separators, and two or more electrodes, such as an anode and cathode, disposed in an enclosure. Each electrode may include a current collector (e.g., a foil) and active material disposed on, for example, one side or two opposing sides of the current collector. In certain manufacturing processes, electrodes may be produced in bulk and then assembled into individual battery cells. For various reasons, such as deviations permitted by engineering tolerances, a size (e.g., thickness) and/or a weight of each electrode may vary. Accordingly, the size and/or the weight of the electrodes in an assembled battery cell may vary, which may lead to battery degradation, reduced battery performance, and/or reduced battery longevity.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment of the present disclosure, a battery electrode matching system includes one or more sensors configured to detect a first characteristic of a first electrode and a second characteristic of a second electrode, one or more signature applicators configured to mark the first electrode with a first signature and the second electrode with a second signature, and memory circuitry. The memory circuitry is configured to store a first profile corresponding to the first electrode, the first profile including first data indicative of the first characteristic and the first signature. The memory circuitry is also configured to store a second profile corresponding to the second electrode, the second profile including second data indicative of the second characteristic and the second signature.

In another embodiment of the present disclosure, a method of battery cell electrode matching includes detecting a first characteristic of a first electrode, marking the first electrode with a first signature, detecting a second characteristic of a second electrode, and marking the second electrode with a second signature. The method also includes storing, in memory circuitry, first data indicative of a first correspondence between the first characteristic and the first signature. The method also includes storing, in the memory circuitry, second data indicative of a second correspondence between the second characteristic and the second signature.

In yet another embodiment of the present disclosure, a battery cell includes a first battery electrode comprising a first unique signature associated with a first size or weight characteristic of the first battery electrode. The battery cell also includes a second battery electrode comprising a second unique signature associated with a second size or weight characteristic of the second battery electrode.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a schematic block diagram of a battery cell configured to power the electronic device of FIG. 1 and including electrode signatures, according to embodiments of the present disclosure;

FIG. 3 is a schematic view of an electrode matching system for producing, marking, measuring, and matching electrodes (e.g., an anode and a cathode) of the battery cell of FIG. 2, according to embodiments of the present disclosure;

FIG. 4 is a top-down view of a foil signature pattern for a current collector sheet configured to include a continuous active material coating thereon, according to embodiments of the present disclosure;

FIG. 5 is a top-down view of a signature pattern corresponding to a continuous active material coating, according to embodiments of the present disclosure;

FIG. 6 is a top-down view of a foil signature pattern for a foil sheet configured to include a zebra active material coating thereon, according to embodiments of the present disclosure;

FIG. 7 is a top-down view of a foil signature pattern for a foil sheet having a zebra active material coating thereon, according to embodiments of the present disclosure;

FIG. 8 is a top-down view of a signature pattern corresponding to a zebra active material coating, according to embodiments of the present disclosure;

FIG. 9 is a top-down view of a foil signature pattern for a foil sheet configured to include discontinuous active material coating thereon, according to embodiments of the present disclosure;

FIG. 10 is a top-down view of a foil signature pattern for a foil sheet having a discontinuous active material coating thereon, according to embodiments of the present disclosure;

FIG. 11 is a top-down view of measurement locations of a current collector sheet, according to embodiments of the present disclosure;

FIG. 12 is a top-down view of measurement locations of a coated current collector sheet, according to embodiments of the present disclosure; and

FIG. 13 is a process flow diagram illustrating a method of assembling a battery cell, including marking, measuring, and matching electrodes of the battery cell, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is generally directed to batteries, such as secondary or rechargeable batteries (e.g., lithium-ion batteries, nickel manganese cobalt batteries, nickel cobalt aluminum batteries, nickel-metal hydride batteries, nickel-cadmium batteries, lithium iron phosphate batteries, lithium-ion polymer batteries, etc.). More specifically, the present disclosure is directed to electrode marking and matching in battery cells.

Battery cells typically include, among other features, an electrolyte, one or more separators, and two or more electrodes, such as one or more anodes and one or more cathodes, disposed in an enclosure. In certain manufacturing processes, electrodes (or portions thereof) may be produced in bulk and then assembled into individual battery cells. For example, a first current collector sheet (e.g., first foil sheet, such as first copper foil sheet) may be coated with a first active material and cut (or “slit”) into multiple electrodes, such as multiple anodes. A second current collector sheet (e.g., second foil sheet, such as an aluminum foil sheet) may be coated with a second active material and cut (or “slit”) into multiple electrodes, such as cathodes. The first and second active materials may differ depending on the embodiment.

Sizes, such as thicknesses, and/or weights of the electrodes may differ for various reasons, including but not limited to deviations permissible by engineering tolerances, limitations and manufacturing techniques, etc. However, it may be desirable that each battery cell include electrodes having substantially similar sizes and/or weights (e.g., within a threshold percentage), or some other desired relationship between their sizes and/or weights. For example, it may be desirable that the battery cell includes at least one anode having a substantially similar size and/or weight as at least one cathode, or includes a size and/or weight with a pre-defined target relationship relative to the size and/or weight of the cathode. Additionally or alternatively, it may be desirable that a battery cell employing multiple anodes and multiple cathodes includes a substantially similar size and/or weight for each anode and a substantially similar size and/or weight for each cathode. In this way, a capacity ratio (referred to in certain instances as an N/P ratio) is controllable to a target that may improve battery longevity and performance, among other technical benefits.

In accordance with the present disclosure, an electrode matching system is employed to assemble a battery cell including electrodes having substantially similar sizes, weights, or other physical characteristics (e.g., within a threshold percentage), or having some other pre-defined target relationship between such physical characteristics (e.g., to control a capacity or N/P ratio of the battery). The electrode matching system includes a signature applicator configured to mark each electrode with a signature (e.g., unique signature). For example, the unique signature may include Quick Response (QR) codes, barcodes, laser etchings, ink markings, or any combination thereof. In some embodiments, the signatures are disposed on the current collectors (e.g., the foils) of the electrodes, such as locations of the current collectors that are not covered by active material. Additionally or alternatively, the signatures may be disposed on the active material of the electrodes. In certain embodiments, multiple signatures may be employed on a single electrode (e.g., one on the current collector, another on the active material, etc.).

The electrode matching system also includes one or more measurement devices (e.g., sensors) configured to detect one or more physical characteristics (e.g., a size, such as a thickness, and/or a weight) of each electrode. The sensor(s) may include, for example, a beta sensor configured to detect the thickness and/or the weight of the electrode. In certain embodiments, for example, the beta sensor may take multiple measurements of each electrode, or each area corresponding to each electrode on a continuous sheet (e.g. current collector sheet), and employ such multiple measurement to estimate the thickness and/or the weight of each electrode. In some embodiments, thickness and/or weight may be determined for the current collector sheet of the electrode, the active material of the electrode, or both.

Further, the electrode matching system may include a storage device, such as memory circuitry and/or a database system, for storing the above-described information. For example, the database system may include an electrode profile for each electrode, the electrode profile storing data indicative of the physical characteristic(s) of the electrode and the signature (e.g., unique signature) of the electrode. Additionally or alternatively, the electrode profile may include a correspondence or datalink between the signature of the electrode and the physical characteristic(s) of the electrode.

During an assembly process of a battery cell, a matching assembly (e.g., a scanner, a controller, processing circuitry, memory circuitry, logic, etc.) of the electrode matching system may be employed to detect (e.g., scan) the signatures of the electrodes and, based on such detection, access the database system, such as accessing the electrode profiles corresponding to the electrodes. In this way, the matching assembly may locate the physical characteristic(s) (e.g., sizes, such as thicknesses, and/or weights) of the electrodes. Further, the matching assembly may be employed to select electrodes (e.g., an anode and a cathode) having sufficiently similar physical characteristics (e.g., within threshold percentages), or some other pre-defined relationship between such physical characteristics, for inclusion in a battery cell. Additionally or alternatively, the matching assembly may block, not select, deselect, or remove electrodes that do not have sufficiently similar physical characteristics, or some other pre-defined relationship between such physical characteristics, from being included in the same battery cell. In some embodiments, the electrodes may be sorted by physical characteristic(s) (e.g., sizes, such as thickness and/or weight) and all or some of the matching assembly is not needed. In these and/or other embodiments, the signatures on the electrodes may be employed at battery pack or cell teardown to identify and/or diagnose failure modes, responsible electrodes of such failure modes, etc. These and other aspects of the present disclosure are described in detail below with reference to the drawings.

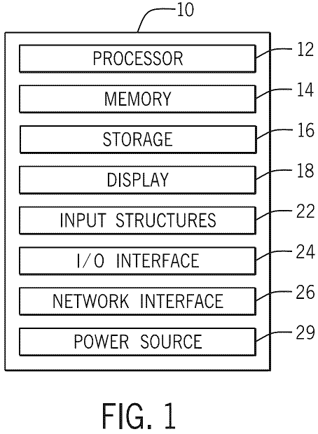

Continuing now with the drawings, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

The power source 29 of the electronic device 10 may include any suitable source of power, such as a rechargeable lithium polymer (Li-poly) battery and/or an alternating current (AC) power converter. In accordance with the present disclosure, the battery of the power source 29 may include electrode signatures configured to facilitate a matching technique by which electrodes with sufficiently compatible physical characteristic(s) (e.g., sizes, such as thicknesses and/or weights), or some other pre-defined relationship therebetween, are selected for inclusion in the battery. Additionally or alternatively, the matching assembly facilitated by the electrode signatures may block, not select, deselect, or remove electrodes that do not have sufficiently similar physical characteristics, or some other pre-defined relationship therebetween, from being included in the same battery cell. Additionally or alternatively, the electrode signatures may be employed at battery pack or cell teardown to identify and/or diagnose failure modes, responsible electrodes of such failure modes, etc. These and other aspects of the present disclosure are described in detail below with reference to the drawings.

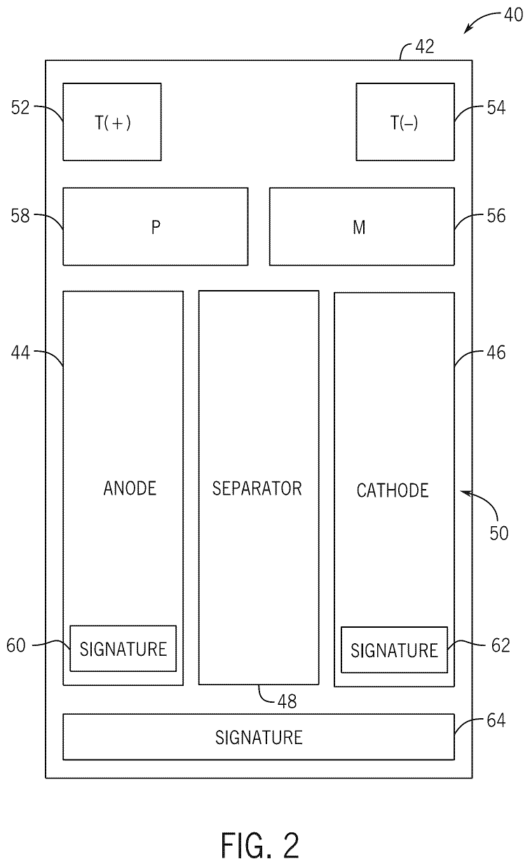

FIG. 2 is a schematic block diagram of an embodiment of a battery cell 40 including electrode signatures. The battery cell 40 includes an enclosure 42, a first electrode 44 (e.g., anode) configured to be disposed in the enclosure 42, and a second electrode 46 (e.g., cathode) configured to be disposed in the enclosure 42. A separator 48 is disposed in the enclosure 42 between the first electrode 44 and the second electrode 46. The first electrode 44, the second electrode 46, and the separator 48 may form an electrode assembly 50 of the battery cell 40, which may be soaked in or wetted by an electrolyte disposed in the enclosure 42. While the electrode assembly 50 in the illustrated embodiment includes the first electrode 44, the second electrode 46, and the separator 48 for purposes of simplicity, it should be understood that the electrode assembly 50 may include, in other embodiments, additional instances of the first electrode 44, the second electrode 46, and/or the separator 48. Indeed, FIG. 2 is merely a block diagram of an embodiment of the battery cell 40 in the present disclosure. It should be understood that the electrode assembly 50 of the battery cell 40 may include a stacked configuration (e.g., including multiple instances of the first electrode 44 or anode, the second electrode 46 or cathode, and/or the separator 48), a jelly roll configuration (e.g., including the first electrode, the second electrode 46, and the separator 48 wound in a jelly roll shape), or any other suitable electrode assembly configuration.

In general, the electrode assembly 50 is electrically coupled with a first terminal 52 (e.g., positive terminal) and a second terminal 54 (e.g., negative terminal) of the battery cell 40. For example, electrodes tabs (or current collector tabs) of the electrodes 44, 46, illustrated in later drawings, may be employed to electrically couple the electrode assembly 50 with the first and second terminals 52, 54. Further, the first and second terminals 52, 54 may be coupled to a load, for example, to enable the battery cell 40 to power the load. In some embodiments, the first and second terminals 52, 54 are coupled to other battery cells via a bussing assembly (e.g., bus bars) to form an interconnected group of batteries (e.g., battery cells) of a battery pack, where the battery pack is configured to power the load. The battery cell 40 in FIG. 2 also includes memory circuitry 56 storing instructions thereon, and processing circuitry 58 configured to execute the instructions to perform various functions, such as monitoring operating conditions of the battery cell 40, regulating charging and discharging cycles of the battery cell 40, etc.

In the illustrated embodiment, the anode 44 includes a first signature 60 and the cathode 46 includes a second signature 62. The first signature 60 may be different than the second signature 62. That is, the first signature 60 and the second signature 62 may be unique signatures for the purpose of, for example, identifying and/or differentiating the corresponding components (e.g., the anode 44 and the cathode 46). Depending on the embodiment, each of the first signature 60 and the second signature 62 may include a Quick Response (QR) code, a barcode, a laser etching, an ink marking, some other type of signature, or any combination thereof. In some embodiments, the signatures 60, 62 are disposed on exposed portions of current collectors (e.g., foils) of the electrodes 44, 46, respectively, where the exposed portions are not covered by active materials of the electrodes 44, 46. The exposed portions may include, for example, the electrode tabs (or current collector tabs) described above. Additionally or alternatively, the signatures 60, 62 may be disposed on portions of the current collectors (e.g., foils) covered by (e.g., coated with) the active materials. Additionally or alternatively, the signatures 60, 62 may be disposed on the active materials of the electrodes 44, 46.

As described in greater detail with reference to later embodiments, a battery electrode matching system (not shown in FIG. 2) may determine and store (e.g., in memory and/or a database) first data indicative of the first signature 60 and one or more first characteristics (e.g., one or more first physical characteristics, such as a first thickness and/or a first weight) of the first electrode 44, and second data indicative of the second signature 62 and one or more second characteristics (e.g., one or more second physical characteristics, such as a second thickness and/or a second weight) of the second electrode 46. For example, the battery electrode matching system may include a sensor, such as a beta sensor, configured to detect electrode thickness and/or electrode weight. In some embodiments, the battery electrode matching system is configured to determine and/or store the first data and the second data described above during an electrode manufacturing process, such as one where battery electrodes are produced in bulk prior to the battery electrodes being selected for and/or assembled into batteries.

The first data and the second data described above may be later recalled during a battery assembly process (e.g., via scanning of the signatures 60, 62) to pair, for example, the first electrode 44 and the second electrode 46 for inclusion in the battery cell 40. Such pairing may be based on, for example, the one or more first characteristics of the first electrode 44 and the one or more second characteristics of the second electrode 46 being relatively similar (e.g., within a threshold percentage of one another), or meeting some other pre-defined relationship therebetween. In this way, electrodes having relatively dissimilar characteristics, or characteristics that do not meet some other desired pre-defined target relationship, may be excluded for pairing in a common battery. Indeed, undesirable electrode pairing may otherwise lead to battery degradation, reduced battery performance, and/or reduced battery longevity. Thus, use of the signatures 60, 62 illustrated in FIG. 2 and the battery electrode matching system, described in detail with reference to later drawings, may reduce battery degradation, improve battery performance, and/or improve battery longevity by pairing electrodes with relatively similar characteristics (e.g., thickness and/or weight).

Additionally or alternatively, the signatures 60, 62 of the electrodes 44, 46, respectively, may be employed at battery tear down to diagnose battery failure and/or other conditions. For example, the first and second characteristics of the first and second electrodes 44, 46, respectively, may be recalled after failure and/or end-of-life of the battery cell 40 by scanning the respective signatures 60, 62 during battery tear down, and the first and second characteristics may inform diagnoses of any failure modes of the battery cell 40. In some embodiments, such as embodiments employing a battery pack with multiple instances of the battery cell 40, a battery-level and/or electrode assembly-level signature 64 may be employed for the same or similar reasons.

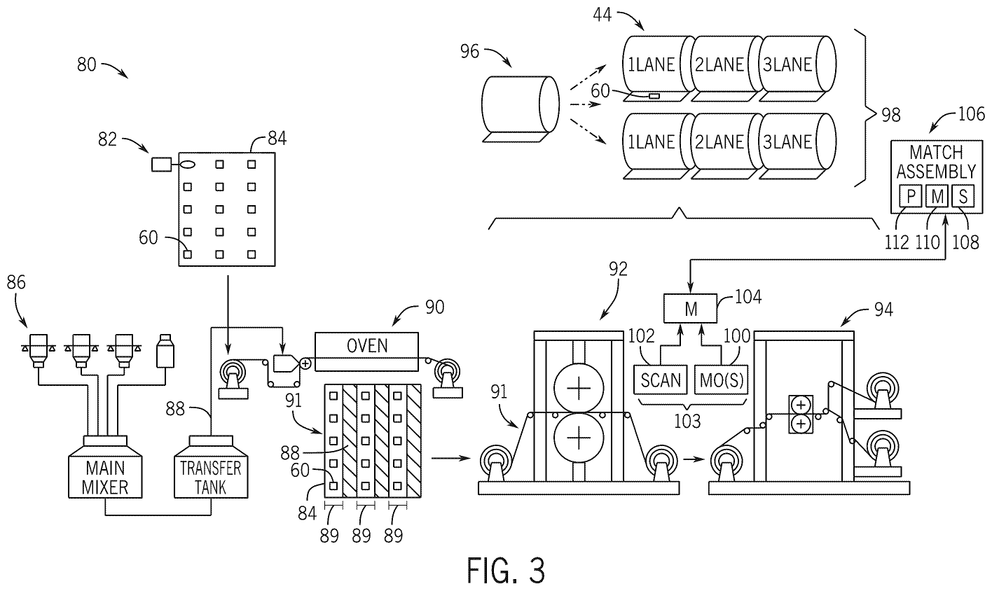

FIG. 3 is a schematic view of an embodiment of an electrode matching system 80 for producing, marking, measuring, and matching the electrodes 44, 46 (e.g., anode and cathode, respectively) of the battery cell 40 of FIG. 2 and/or other electrodes. In the illustrated embodiment, the system 80 includes a signature applicator 82 configured to mark, for example, a current collector (e.g., foil) sheet 84 (and/or other electrode features, such as active materials) with various signatures, such as the first signature 60 corresponding to the first electrode 44 (e.g., anode) in FIG. 2 (and additional signatures corresponding to additional electrodes, such as additional anodes). While the following description refers to the first signature 60 and the first electrode 44 (e.g., anode), it should be understood that the same or similar system 80 may be employed for the second signature 62 corresponding to the second electrode 46 (e.g., cathode) in FIG. 2. The current collector sheet 84 in the illustrated embodiment may include a copper material corresponding to the anode, while a current collector sheet corresponding to the cathode may include, for example, aluminum. However, other materials are also possible depend on battery chemistry, among other possible factors. Current collector materials may include, for example, aluminum, copper, nickel, titanium, stainless steel, etc.

A mixing assembly 86 of the system 80 is employed to mix various material constituents to form an active material 88 (e.g., slurry). The active material for the anode may include, for example, graphite, silicon, other materials, or any combination thereof. The active material for the cathode may include, for example, metal oxides, other materials, or any combination thereof. The system 80 also includes an oven 90 in which the active material 88 is coated onto or otherwise adhered to the current collector sheet 84 (e.g., via heating). In the illustrated embodiment, as shown, the active material 88 is coated onto portions of the current collector sheet 84 that do not overlap with the signature 60 corresponding to the first electrode 44 in FIG. 2 (and additional signatures corresponding to additional electrodes). In this way, the signatures (e.g., including the signature 60) are disposed on exposed portions 89 of the current collector sheet 84. In some embodiments, the exposed portions 89 may correspond to electrode tabs, also referred to as current collector tabs herein.

However, other arrangements described in detail with reference to later drawings may also be possible. For example, in certain embodiments, the signatures (e.g., including the signature 60) may be disposed on portions of the current collector sheet 84 covered by the active material 88, disposed on the active material 88 instead of the current collector sheet 84, disposed on both the active material 88 and the current collector sheet 84, etc. Further, signatures may be disposed on both the current collector sheet 84 and the active material 88. Accordingly, the signature applicator 82 (or multiple such applicators) may be employed before the current collector sheet 84 reaches the oven 90 for coating of the active material 88, after the current collector sheet 84 passes through the oven 90 and is coated by the active material 88, or both.

The current collector sheet 84 with the active material 88 coated thereon, referred to below as a coated current collector sheet 91, may be passed to a roll press 92 configured to reduce a thickness of the coated current collector sheet 91 (e.g., within engineering tolerances), for example, by compressing the coated current collector sheet 91. The coated current collector sheet 91 may then be passed to a slitting device 94 configured to slit (or cut) the coated current collector sheet 91 into individual electrodes 98 (e.g., jelly rolls). For example, as shown, a jumbo roll 96 corresponding to the coated current collector sheet 91 may be slit (or cut) by the slitting device 94 into the individual electrodes 98 (or jelly rolls) corresponding to battery electrodes. However, it should be understood that the same or similar system 80 may be employed for embodiments not employing jelly rolls, such as embodiments employing a stacked electrode configuration.

At some stage in the system 80, such as after the coated current collector sheet 91 passes through the roll press 92, a measurement device 100 (e.g., including a sensor, such as a beta sensor) measures characteristics (e.g., thickness and/or weight) of the current collector sheet 84, the coated current collector sheet 91, or both. For example, the measurement device 100 may measure characteristics on the current collector sheet 84 and/or the coated current collector sheet 91 corresponding to various locations from which electrodes will be derived. For example, the measurement device 100 may measure such characteristics prior to the coated current collector sheet 91 (or jumbo roll 96) being slit (or cut) into the individual electrodes 98 (e.g., jelly rolls).

In some embodiments, the measurement device 100 may take measurements at two or more locations per electrode, and employ the measurements to determine or estimate the thickness and/or the weight of each electrode (or individual constituents thereof, such as the current collector sheet 84, the active material 88, or a combination thereof) that is ultimately derived from the coated current collector sheet 91. Further, a scanner 102 may scan the signatures (e.g., including the 60 corresponding to the electrode 44 of FIG. 2). In some embodiments, the scanner 102 and the measurement device 100 may form an assembly 103 (e.g., integrated assembly), and the assembly 203 may be configured to store, in memory 104 (e.g., a database), profiles corresponding electrodes derived from the coated current collector sheet 91 (e.g., the individual electrode rolls 98). That is, each electrode (e.g., including the first electrode 44 and the second electrode 46 of FIG. 2) may include a profile stored to the memory 104, where the profile includes data indicative of the signature and data indicative of the characteristic(s) (e.g., thickness and/or weight) determined by way of the measurement device 100.

During an assembly process of the battery cell 40 of FIG. 2, for example, an electrode matching assembly 106 of the system 80 in FIG. 3 may be employed to scan, for example, the signature(s) 60 on the first electrode 44 of FIG. 2. In some embodiments, the electrode matching assembly 106 includes an additional scanner 108, memory circuitry 110 storing instructions thereon, and processing circuitry 112 configured to execute the instructions to perform various functions. In response to the additional scanner 108 scanning the signature 60 of the first electrode 44, the processing circuitry 112 of the electrode matching assembly 106 may receive, from the memory 104 (e.g., database), data indicative of the electrode profile corresponding to the first electrode 44, such as data indicative of the physical characteristics (e.g., thickness and/or weight) of the first electrode 44. In some embodiments, only one of the scanners 102, 108 is employed in the system 80 (e.g., for first storing data in electrode profiles, and then recalling such data for pairing various electrodes).

As previously described, the first electrode 44 may be an anode. The processing circuitry 112 may employ the data indicative of the physical characteristic(s) of the first electrode 44, or anode, to identify another electrode (e.g., the second electrode 46 in FIG. 2, or cathode) having sufficiently related (e.g., similar) physical characteristics for inclusion in a common battery, such as the battery cell 40 of FIG. 2. Additionally or alternatively, in embodiments employing multiple anodes and multiple cathodes in a common battery, the same or similar techniques may be employed to locate multiple anodes with sufficiently related (e.g., similar) physical characteristics, multiple cathodes with sufficiently related (e.g., similar) characteristics, or both. It should be noted that FIG. 2 is merely an example of the battery cell 40 in accordance with the present disclosure, and that other examples (e.g., employing componentry in different locations and/or orders) are also possible.

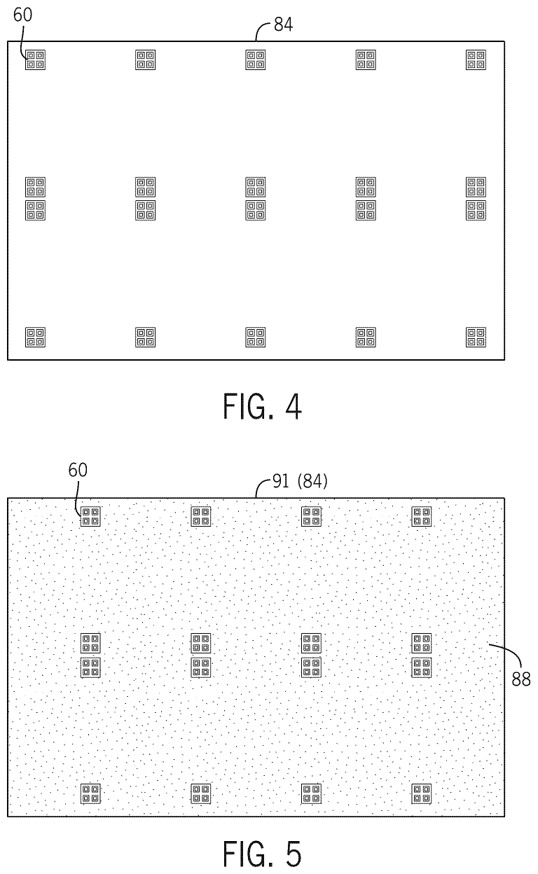

Signature patterns and number of signatures may differ depending on the embodiment, for example, depending on the type of active material coating, the type of electrode assembly, and/or the type of battery. FIGS. 4-10 illustrate various such examples. FIGS. 4 and 5, for example, correspond to an embodiment including a continuous active material coating. FIG. 4 includes the current collector sheet 84 before the continuous active material coating, and FIG. 5 includes the coated current collector sheet 91 (i.e., including the continuous coating of the active material 88 on the current collector sheet 84). In FIG. 4, the signatures 60 are disposed on the current collector sheet 84. In FIG. 5, the signatures 60 may be disposed on the current collector sheet 84 (i.e., underneath the active material 88) or on the active material 88 itself. Indeed, as previously described, measurements of various characteristics (e.g., thickness and/or weight) may be taken of the current collector sheet 84, the active material 88, or the combination thereof (e.g., the coated current collector sheet 91), where such characteristics are later employed to pair or match electrodes having sufficiently related (e.g., similar) characteristics, such as sufficiently related (e.g., similar) current collector thickness, current collector weight, active material thickness, active material weight, total electrode thickness, total electrode weight, etc. It should be understood that each of the signatures 60 in FIGS. 4 and 5 may be unique relative to each other.

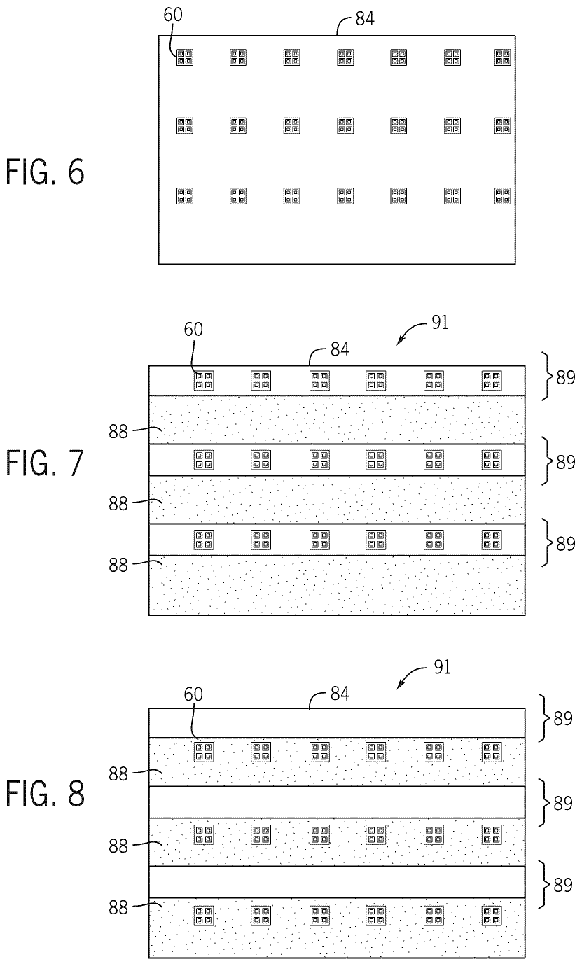

FIGS. 6 and 7, for example, correspond to an embodiment including a zebra active material coating. FIG. 6 includes the current collector sheet 84 before the zebra active material coating, and FIG. 7 includes the coated current collector sheet 91 (i.e., including the zebra coating of the active material 88 on the current collector sheet 84). In FIG. 6, the signatures 60 are disposed on the current collector sheet 84. FIG. 7 also illustrates the signatures 60 disposed on the exposed portions 89 of the current collector sheet 84, as previously described with respect to FIG. 3. The zebra coating refers to the stripes (e.g., three stripes) of the active material 88 coated on the current collector sheet 84 to form the coated current collector sheet 91. FIG. 8 also corresponds to an embodiment including a zebra active material coating, where the signatures 60 are disposed on the active material 88. Although FIG. 8 does not illustrate signatures on the exposed portions 89 of the current collector sheet 84, in some embodiments, signatures may be disposed on both the exposed portions 89 of the current collector sheet 84 and the active material 88, as previously described. It should be understood that each of the signatures 60 in FIGS. 6-8 may be unique relative to each other.

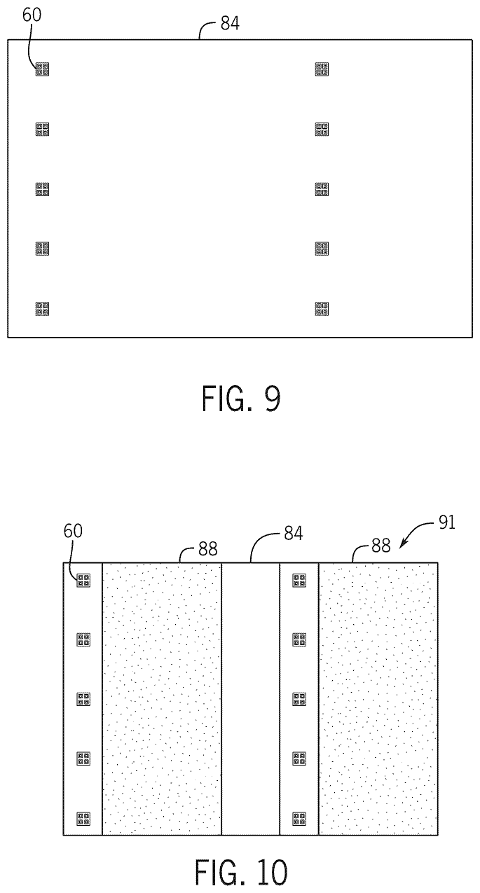

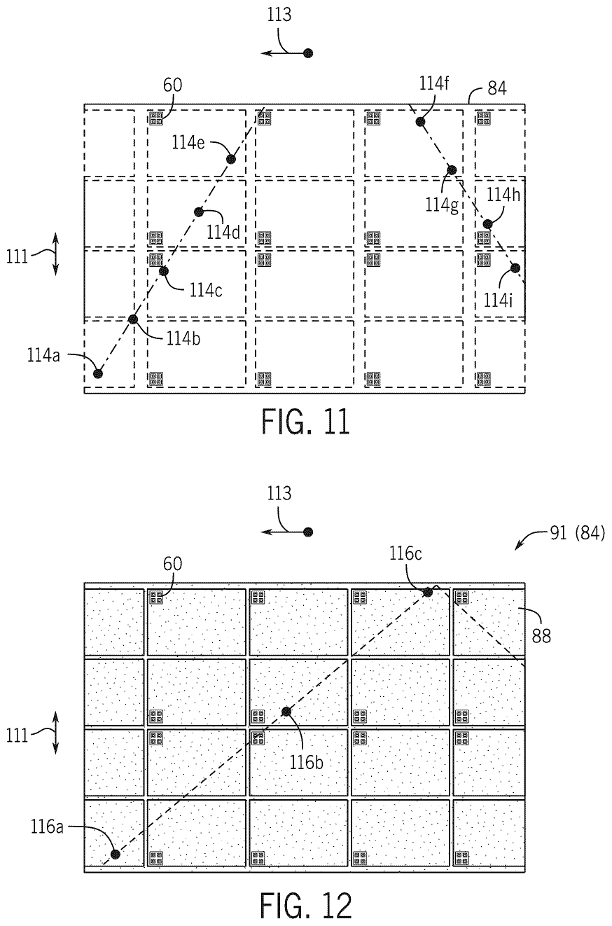

FIGS. 9 and 10, for example, correspond to an embodiment including a discontinuous active coating. FIG. 9 includes the current collector sheet 84 before the discontinuous active material coating, and FIG. 10 includes the coated current collector sheet 91 (i.e., including the discontinuous coating of the active material 88 on the current collector sheet 84). In FIG. 9, the signatures 60 are disposed on the current collector sheet 84. FIG. 10 also illustrates the signatures 60 disposed on the exposed portions 89 of the current collector sheet 84. While FIGS. 9 and 10 illustrate different numbers of the signatures 60, it should be understood FIGS. 9 and 10 are merely schematic illustrations of an example discontinuous active coating. Other arrangements are also possible. Further, it should be understood that each of the signatures 60 in FIGS. 9 and 10 may be unique relative to each other.

FIG. 11 is a top-down view of measurement locations on an embodiment of the current collector sheet 84. For example, measurements may be taken on the current collector sheet 84 without active material coated or otherwise disposed thereon. In certain embodiments, measurements may be taken by a measurement device, such as a sensor (e.g., beta sensor), that is translated along a width direction 121 as the current collector sheet 84 is translated along a length direction 113 transverse to the width direction 111. In this way, various measurements 114a, 114b, 114c, 114d, 114e, 114f, 114g, 114h, 114i may be taken at various locations on the current collector sheet 84, where said measurements 114a, 114b, 114c, 114d, 114e, 114f, 114g, 114h, 114i are employed to estimate, infer, or otherwise determine characteristics (e.g., thicknesses and/or weights) of the current collectors of various electrodes later derived from the current collector sheet 84.

As previously described, measurements may be taken after active material is disposed on the current collector sheet 84. For example, FIG. 12 is a top-down view of measurement locations on an embodiment of the coated current collector sheet 91 (e.g., including the current collector sheet 84 and the active material 88 disposed thereon). Measurements 116a, 116b, 116c may be taken of the coated current collector sheet 91 in the same or similar manner as outlined above with respect to the current collector sheet 84 of FIG. 11, and at various locations on the coated current collector sheet 91. The measurements 116a, 116b, 116c are employed to estimate, infer, or otherwise determine characteristics (e.g., thicknesses and/or weights) of various electrodes (or active material of the electrodes) later derived from the coated current collector sheet 61.

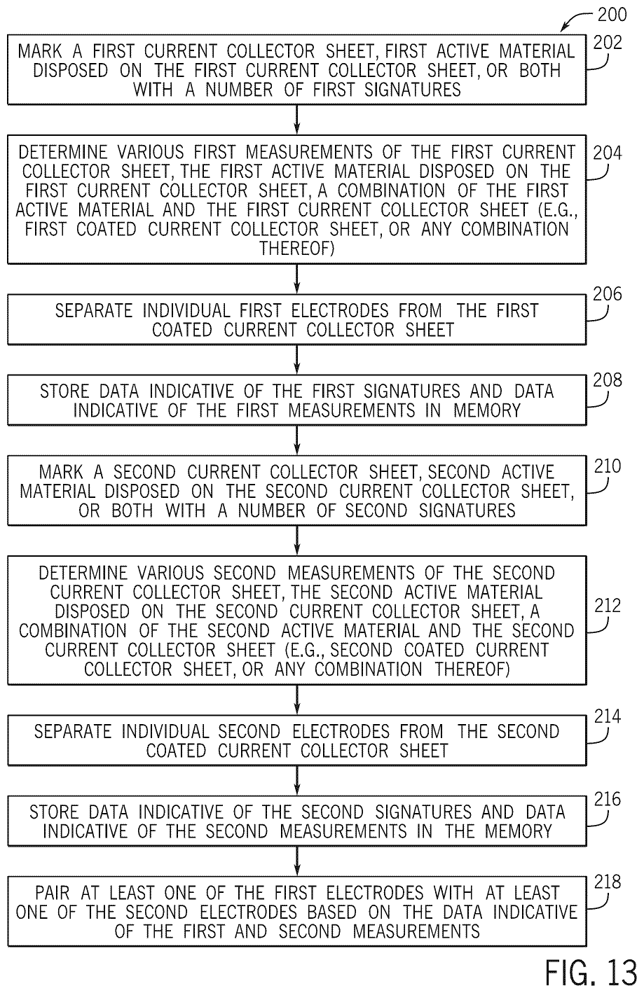

FIG. 13 is a process flow diagram illustrating an embodiment of a method 200 of assembling a battery cell, including marking, measuring, and matching electrodes of the battery cell. It should be understood that the order of steps of the method 200 illustrated in FIG. 12, and the order of the description of such steps below, should not be taken as necessarily implying a chronology of the steps of the method 200. Further, in certain embodiments, certain steps illustrated in FIG. 12 may be omitted from the method 200 and/or certain steps not illustrated in FIG. 12 may be included in the method 200.

In the illustrated embodiment, the method 200 includes marking (block 202) a first current collector sheet, first active material disposed on the first current collector sheet, or both with a number of first signatures (e.g., first unique signatures). As previously described, a number of first electrodes (e.g., anodes) may be derived from the first coated current collector sheet. Each first electrode may include at least one first signature, such as at least one first signature on the current collector sheet, at least one signature on the active material coated on the current collector sheet, or both.

The method 200 also includes determining (block 204) various first measurements of the first current collector sheet, the first active material disposed on the first current collector sheet, the combination of the first active material and the first current collector sheet (e.g., the first coated current collector sheet), or any combination thereof. The first measurements may include, for example, thicknesses and/or weights of the componentry described above. In some embodiments, two or more first measurements may be taken for each first electrode (e.g., anode) ultimately derived from the first current collector sheet. As previously described, the first measurements may be taken by a sensor, such as a beta sensor, and the thicknesses and/or weights may be determined based on sensor data from the sensor.

The method 200 also includes separating (block 206) individual first electrodes from the first coated current collector sheet. For example, the first coated current collector sheet may be slit (or cut) into individual first electrodes, such as anodes, where each individual first electrode includes at least one first signature, as previously described. The method 200 also includes storing (block 208), in memory, data indicative of the first signatures and data indicative of the first measurements. In some embodiments, first electrode profiles corresponding to the first electrodes may be stored in the memory.

The method 200 includes marking (block 210) a second current collector sheet, second active material disposed on the second current collector sheet, or both with a number of second signatures (e.g., second unique signatures). As previously described, a number of second electrodes (e.g., cathodes) may be derived from the second coated current collector sheet. Each second electrode may include at least one second signature, such as at least one second signature on the current collector sheet, at least one signature on the active material coated on the current collector sheet, or both.

The method 200 also includes determining (block 212) various second measurements of the second current collector sheet, the second active material disposed on the second current collector sheet, the combination of the second active material and the second current collector sheet (e.g., the second coated current collector sheet), or any combination thereof. The second measurements may include, for example, thicknesses and/or weights of the componentry described above. In some embodiments, two or more second measurements may be taken for each second electrode (e.g., cathodes) ultimately derived from the second current collector sheet. As previously described, the second measurements may be taken by a sensor, such as a beta sensor, and the thicknesses and/or weights may be determined based on sensor data from the sensor.

The method 200 also includes separating (block 214) individual second electrodes from the second coated current collector sheet. For example, the second coated current collector sheet may be slit (or cut) into individual second electrodes, such as cathodes, where each individual first electrode includes at least one first signature, as previously described. The method 200 also includes storing (block 216), in memory, data indicative of the second signatures and data indicative of the second measurements. In some embodiments, second electrode profiles corresponding to the second electrodes may be stored in the memory.

The method 200 also includes pairing (block 218) at least one of the first electrodes (e.g., anode) with at least one of the second electrodes (e.g., cathode) based on the characteristics thereof meeting a pre-defined relationship (e.g., being within a threshold percentage of each other, being different from each other by a pre-defined preferred amount, etc.). For example, a scanner may be employed to scan a first signature corresponding to one of the first electrodes, and a second signature corresponding to tone of the second electrodes. Such scanning may retrieve, from the memory, data indicative of the characteristics of the first electrode and the second electrode. Based on the data indicative of the characteristics, the first electrode may be paired with the second electrode (e.g., in response to the characteristics meeting a pre-defined relationship), or excluded from being paired together (e.g., in response to the characteristics not meeting the pre-defined relationship).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery electrode matching system, comprising:
one or more sensors configured to detect a first characteristic of a first electrode and a second characteristic of a second electrode;
one or more signature applicators configured to mark the first electrode with a first signature and the second electrode with a second signature; and
memory circuitry configured to store:
a first profile corresponding to the first electrode, the first profile comprising first data indicative of the first characteristic and the first signature; and
a second profile corresponding to the second electrode, the second profile comprising second data indicative of the second characteristic and the second signature.

2. The battery electrode matching system of claim 1, wherein the one or more signature applicators are configured to:
mark a first foil sheet with a first plurality of signatures including the first signature of the first electrode; and
mark a second foil sheet with a plurality of second plurality of signatures including the second signature of the second electrode.

3. The battery electrode matching system of claim 1, comprising an electrode matching assembly configured to:
receive at least a first portion of the first profile from the memory circuitry based on detecting the first signature of the first electrode;
receive at least a second portion of the second profile from the memory circuitry based on detecting the second signature of the second electrode; and
pair the first electrode with the second electrode for use in a battery cell based on the first characteristic meeting a pre-defined relationship with respect to the second characteristic.

4. The battery electrode matching system of claim 3, wherein the pre-defined relationship corresponds to the first characteristic of the first electrode being within a threshold percentage of the second characteristic of the second electrode.

5. The battery electrode matching system of claim 1, comprising an electrode matching assembly configured to:
receive at least a first portion of the first profile from the memory circuitry in response to detecting the first signature of the first electrode;
receive at least a second portion of the second profile from the memory circuitry in response to detecting the second signature of the second electrode; and
exclude the first electrode from being paired with the second electrode for use in a battery cell based on the first characteristic not meeting a pre-defined relationship with respect to the second characteristic.

6. The battery electrode matching system of claim 1, wherein the one or more signature applicators are configured to:
mark a first active material of the first electrode with the first signature; and
mark a second active material of the second electrode with the second signature.

7. The battery electrode matching system of claim 1, wherein the one or more sensors comprise a sensor configured to detect electrode thicknesses corresponding to the first characteristic, the second characteristic, or both.

8. The battery electrode matching system of claim 1, wherein the one or more signature applicators are configured to:
mark a first foil of the first electrode with the first signature in a first area not designated to be covered by first active material of the first electrode; and
mark a second foil of the second electrode with the second signature in a second area not designated to be covered by second active material of the second electrode.

9. The battery electrode matching system of claim 8, wherein the first area comprises a first current collector tab of the first electrode, and the second area comprises a second current collector tab of the second electrode.

10. A method of battery cell electrode matching, comprising:
detecting a first characteristic of a first electrode;
marking the first electrode with a first signature;
detecting a second characteristic of a second electrode;
marking the second electrode with a second signature;
storing, in memory circuitry, first data indicative of a first correspondence between the first characteristic and the first signature; and
storing, in the memory circuitry, second data indicative of a second correspondence between the second characteristic and the second signature.

11. The method of claim 10, comprising:
determining an additional first characteristic of the first electrode;
determining an additional second characteristic of the second electrode;
storing, in the memory circuitry, the first data indicative of the first correspondence between the first characteristic, the additional first characteristic, and the first signature; and
storing, in the memory circuitry, the second data indicative of the second correspondence between the second characteristic, the additional second characteristic, and the second signature.

12. The method of claim 11, wherein:
the first characteristic corresponds to a first thickness of the first electrode, and the additional first characteristic corresponds to a first weight of the first electrode; and
the second characteristic corresponds to a second thickness of the second electrode, and the additional second characteristic corresponds to a second weight of the second electrode.

13. The method of claim 10, comprising:
receiving at least a first portion of the first data based on detecting the first signature;
receiving at least a second portion of the second data based on detecting the second signature; and
pairing the first electrode with the second electrode for use in a battery cell based on the first characteristic meeting a pre-defined relationship with respect to the second characteristic.

14. The method of claim 10, comprising:
receiving at least a first portion of the first data based on detecting the first signature;
receiving at least a second portion of the second data based on detecting the second signature;
determining whether the first characteristic meets a pre-defined relationship with respect to the second characteristic; and
excluding the first electrode from being paired with the second electrode for use in a battery cell based on the first characteristic not meeting the pre-defined relationship with respect to the second characteristic.

15. The method of claim 10, comprising:
marking a first foil corresponding to the first electrode or a first active material corresponding to the first electrode with the first signature; and
marking a second foil corresponding to the second electrode or a second active material corresponding to the second electrode with the second signature.

16. The method of claim 10, comprising:
marking the first electrode with a first Quick Response (QR) code or barcode corresponding to the first signature; and
marking the second electrode with a second Quick Response (QR) code or barcode corresponding to the second signature.

17. A battery cell, comprising:
a first battery electrode comprising a first unique signature associated with a first size or weight characteristic of the first battery electrode; and
a second battery electrode comprising a second unique signature associated with a second size or weight characteristic of the second battery electrode.

18. The battery cell of claim 17, wherein the first unique signature is disposed on a first foil of the first battery electrode, and the second unique signature is disposed on a second foil of the second battery electrode.

19. The battery cell of claim 17, wherein the first battery electrode comprises an anode, and the second battery electrode comprises a cathode.

20. The battery cell of claim 17, wherein the first unique signature comprises a first Quick Response (QR) code or barcode, and the second unique signature comprises a second Quick Response (QR) code or barcode.
